(19) United States
(12) Patent Application Publication
(10) Pub. No.: US 2019/0077364 A1
(43) Pub. Date: Mar. 14, 2019

(54) Carseat Belt Attachment

(71) Applicants: Diana L. Murray, SR., North Richland Hills, TX (US); Brian Murray, North Richland Hills, TX (US)

(72) Inventors: Diana L. Murray, SR., North Richland Hills, TX (US); Brian Murray, North Richland Hills, TX (US)

(21) Appl. No.: 16/123,755

(22) Filed: Sep. 6, 2018

Related U.S. Application Data
(60) Provisional application No. 62/556,035, filed on Sep. 8, 2017.

(51) Int. Cl. B60R 22/02; B60R 22/12

(52) U.S. Cl. CPC B60R 22/023; B60R 2022/025; B60R 2022/021; B60R 22/12

(57) ABSTRACT

A child safety seat belt to provide solution for the frustrating and exasperating experience of fighting seatbelts for parents when placing their infants in child car seats is disclosed. The child safety seat belt comprises an attachment frame to snap the existing seat belts on the child car seat. The attachment frame is configured to have three separate segments specially designed to fit at the end of each belt via a connection joint at an upper section, a middle section and a lower section. The connection joint is configured to juxtapose the three separate segments together once the existing seat belt is snapped into the attachment frame and spreads out in upright position to provide access for the parent to take out the child from the seat.

### BACKGROUND OF THE INVENTION

### A. Technical field

The present invention generally relates to a seat belt for a vehicle. The invention is specifically related to a child seat belt attachment used in the vehicle to extend protection and safety while conveniently loading and unloading the child from the seat.

### B. Description of related art

Child safety in automobiles has become an important characteristic of parenting in recent years. Earlier car seats were designed mostly to function as a device to restrain the child in the automobile and prevent the child from moving around in the vehicle. While this provides a certain amount of safety for the child. However, from 1960 onwards the impact safety became important and the designs of the seats began to reflect that trend. The absence of general information on the car seat during this period precluded most parent from employing car seat for their children until the 1970's.

Advocacy for creating a safer environment for children riding in automobiles began to make an impact. But even into the decade of the 1980's the use of car seats for children was not widespread and regulation and laws were just beginning to be written and enforced. Current day parents often research extensively for car seat options and for safety records and reviews. Proper installation and up to date information for child safety seats have become the norm for many parents. Many child safety seats have modern innovations that improve the safety and function of the car seats. Parents are always seeking to improve the capabilities of safety equipment where their children are involved. Leaning into the vehicle, while guiding the child and twisting the body to move the straps around, can cause added physical stress or even back trauma. This is especially true if the car seat is placed in the center of the rear seat so the child can more easily be seen while driving.

A common issue for parents with child safety car seats is that the difficulty of placing the child into the seat in preparation of traveling in the vehicle. A complex system of buckles is often utilized to assure the proper restraint is administered to the child occupying the safety seat. This system of buckles, while they do maintain a safety standard, could be very annoying and exasperating while trying to place the child in the car seat. The buckles often can become lost in the cushions of the seat or become tangled with themselves or each other. Invariably the child will be placed in the car seat and the buckles will consistently collapse back into the seat beneath the child. This results in lifting the child back up to the clear the buckles. The tricky balance of keeping the buckles out of the way and getting the child in the proper position for buckling up can be a frustrating and challenging experience.

Therefore, there is a need for a safety belt attachment to overcome the said limitations and extend protection and safety while conveniently loading and unloading the child from the seat.

### SUMMARY OF THE INVENTION

The present invention relates to a child safety seat belt to provide solution for the frustrating and exasperating experience of fighting seatbelts for parents when placing their infants in child car seats.

In one embodiment, the child safety seat belt is configured to use in association with the seat of a car having at least two shoulder belts leading from laterally spaced-apart locations on a seat back above the locations of the shoulders and a front belt leading from a front center portion of a seat bottom.

In an embodiment, the child safety seat belt comprises an attachment frame to snap the existing seat belts on the child car seat. The attachment frame is made from a high-quality flexible plastic material. The attachment frame is configured to have three separate segments specially designed to fit at the end of each belt via a connection joint at an upper section, a middle section and a lower section.

In one embodiment, the connection joint comprises a first connection member, a second connection member and a third connection member. The first connection member is disposed at the upper section, the second connection member is disposed at the middle section and the third connection member is disposed at the front section. The second connection member and the third connection member are fastened together via a five-point latch. In one embodiment, the first connection member is a belt joiner latch.

The connection joint is configured to juxtapose the three separate segments together once the existing seat belt is snapped into the attachment frame. Two separate segments of the attachment frame are configured to fit the existing shoulder belts and another segment is positioned on the front side to cover the front belt.

In an embodiment, the attachment frame is configured to provide the user or the parent with access to bend the seat belt into almost any position and it will remain in that position until relocated by the user. This also allows the user to preposition the seatbelts in a spread out and upright position. Similarly, when the child is placed in the car seat, the attachment frame could be easily repositioned for buckling the child inside the existing belt.

In another embodiment, the child safety seat belt is configured for use in association with the seat of a car having one or more seat belt. In another embodiment, the child safety seat belt comprises an attachment frame and a connection joint. The attachment frame comprising one or more segments configured to snap onto the seat belt, wherein each segment is made of flexible material. The connection joint is configured to juxtapose the one or more segments. Each segment is configured to hold the belts open on releasing the connection joint, thereby avoiding draping of seat belts.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 illustrates an attachment frame for a child safety seat belt covering the child, incorporating the aspects of the present invention.

FIG. 2 illustrates the child safety seat belt without the attachment frame, incorporating the aspects of the present invention.

FIG. 3 illustrates the attachment frame snapped over the child safety seat belt shown without the child.

FIG. 4 illustrates the attachment frame in a folded position to provide access for the child seated in the existing seat belt.

FIG. 5 illustrates the attachment frame in the folded position shown as extended out from the seat.

FIG. 6 illustrates a front view of the attachment frame snapped over the child safety seat belt.

FIG. 7 illustrates the front view of the attachment frame in the folded position to provide access for the child seated in the existing seat belt.

FIG. 8 illustrates the front view of the attachment frame for a shoulder section and a cross-sectional view, incorporating the aspects of the present invention.

FIG. 9 illustrates the front view of the attachment frame for a front section and the cross-sectional view, incorporating the aspects of the present invention.

FIG. 10 illustrates the attachment frame for the child safety seat belt in a latched position.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

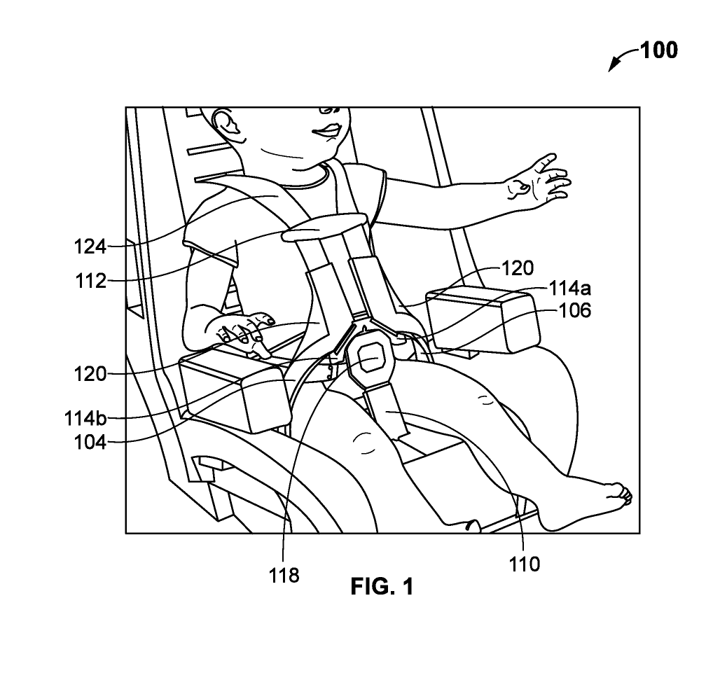

According to FIG. 1, a child safety seat belt 100 is configured to provide solution for the frustrating and exasperating experience of fighting seatbelts for parents when placing their infants in child car seats. In one embodiment, the child safety seat belt 100 is configured to use in association with the seat of a car having at least two shoulder belts leading from laterally spaced-apart locations on a seat back above the locations of the shoulders and a front belt leading from a front center portion of a seat bottom.

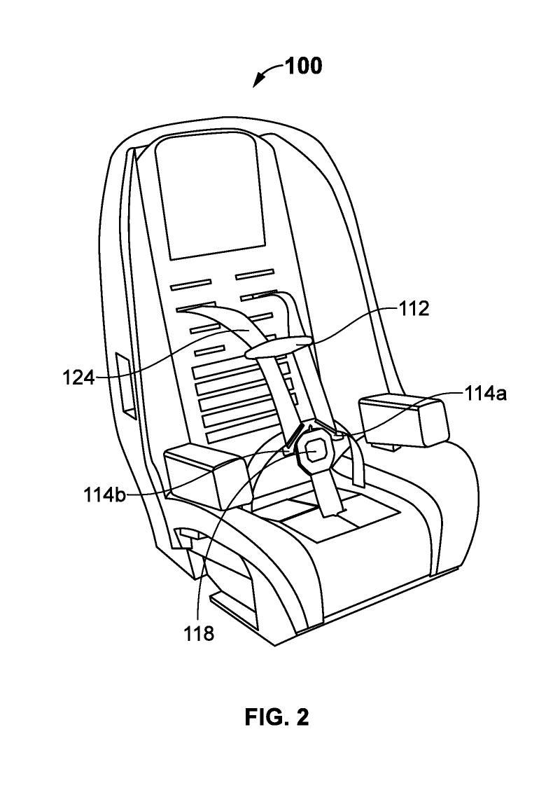

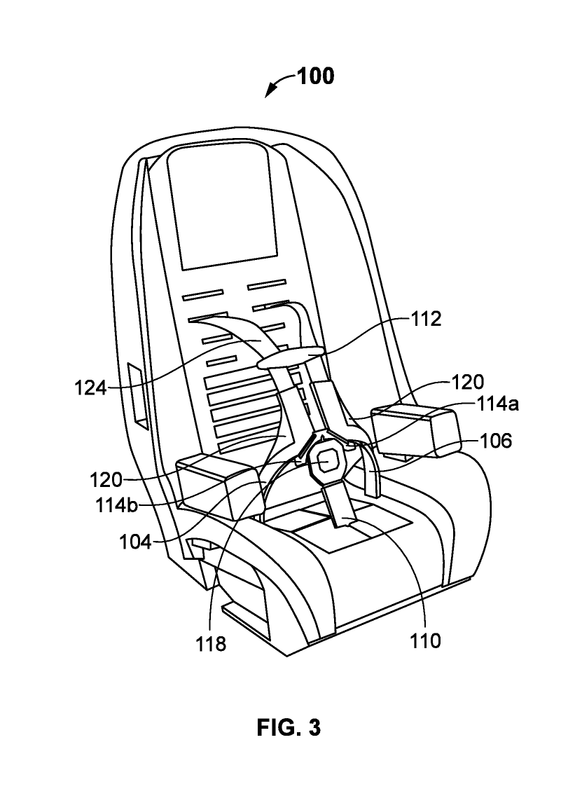

As shown in FIG. 2 which illustrates the child safety seat belt 100 without the attachment frame 102. The child safety seat belt 100 receives the child or infant and keep intact with the seat during the travel. They have latching points to safely hold the child for longer time. The child safety seat belt 100 comprises an attachment frame 102 to snap the existing seat belts 124 on the child car seat. The attachment frame 102 is made from a high-quality flexible plastic material. The attachment frame 102 is configured to have three separate segments (104, 106, 108) specially designed to fit at the end of each belt 124 via a connection joint comprising a first connection member 112, second connection member (114a, 114b) and third connection member 118 as shown in FIG. 3. The first connection member 112 is disposed at an upper section, the second connection member (114a, 114b) is disposed at a middle section and the third connection member 118 is disposed at a front section. The connection joint is configured to juxtapose the three separate segments (104, 106, and 108) together once the existing seat belt 124 is snapped into the attachment frame 102. Two separate segments (104, 106) of the attachment frame 102 are configured to fit the existing shoulder belts 124 and another segment 108 is positioned on the front section 110 to cover the front belt.

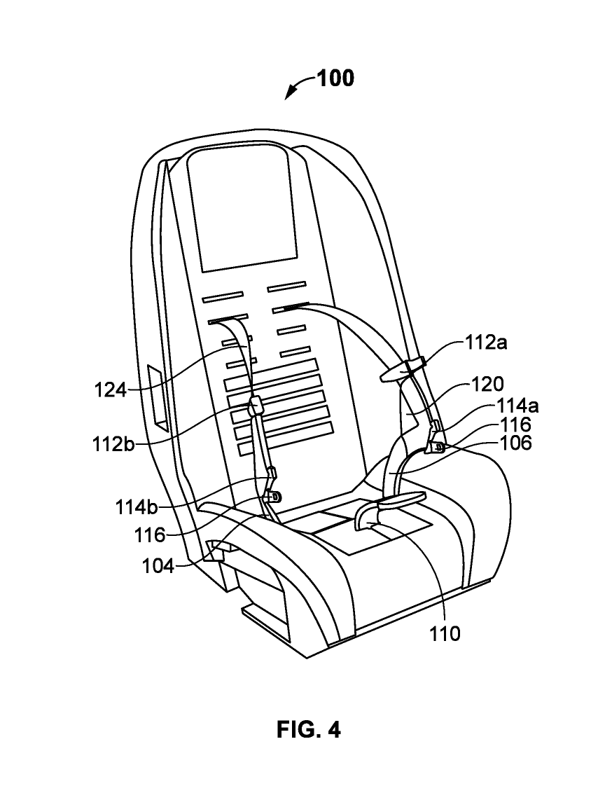

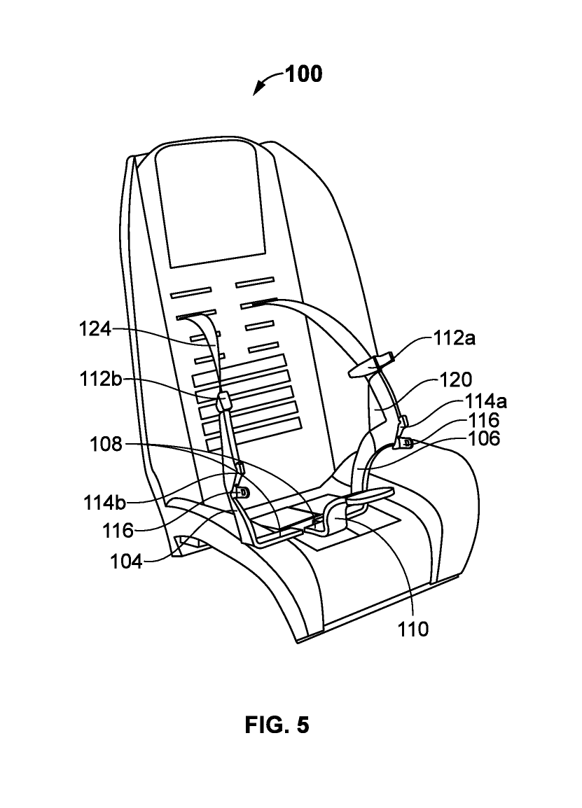

In one embodiment as shown in FIG. 4, the attachment frame 102 is configured to provide the user or the parent with access to bend the seat belt 124 into almost any position and it will remain in that position until relocated by the user. This also allows the user to preposition the seatbelts 124 in a spread out and upright position. Similarly, when the child is placed in the car seat, the attachment frame 102 could be easily repositioned for buckling the child inside the existing belt 124. The lower section 108 of the attachment frame 102 is configured to slide under the existing seat so that the attachment frame 102 is stably mounted on the child safety seat belt 100 as shown in FIG. 5. The first connection member 112 as two sections (112a, 112b) to open the two side segments (104, 106) move the seat belt 124 outboard and vertical.

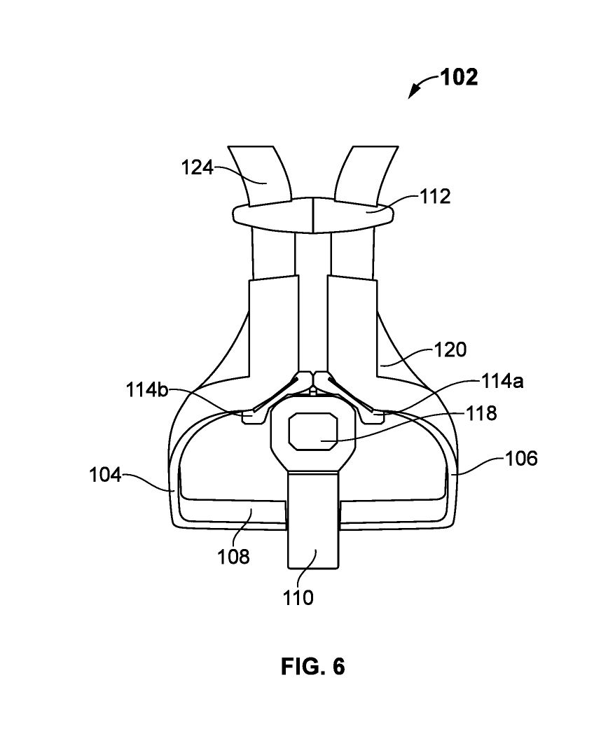

FIG. 6 illustrates a front view of the attachment frame 102 snapped over the child safety seat belt 100. The attachment frame 102 is flexible and designed to work with existing automotive child car seat belts 100. The three separate segments (104, 106, and 108) of the attachment frame 102 are also flexible and snap over the respective sections of the existing seat 124 belt close to the connection joints and therefore, it provides easy and immediate access for the user to get access for all the latches to secure the child. This also eliminates the fumbling of the connection joints.

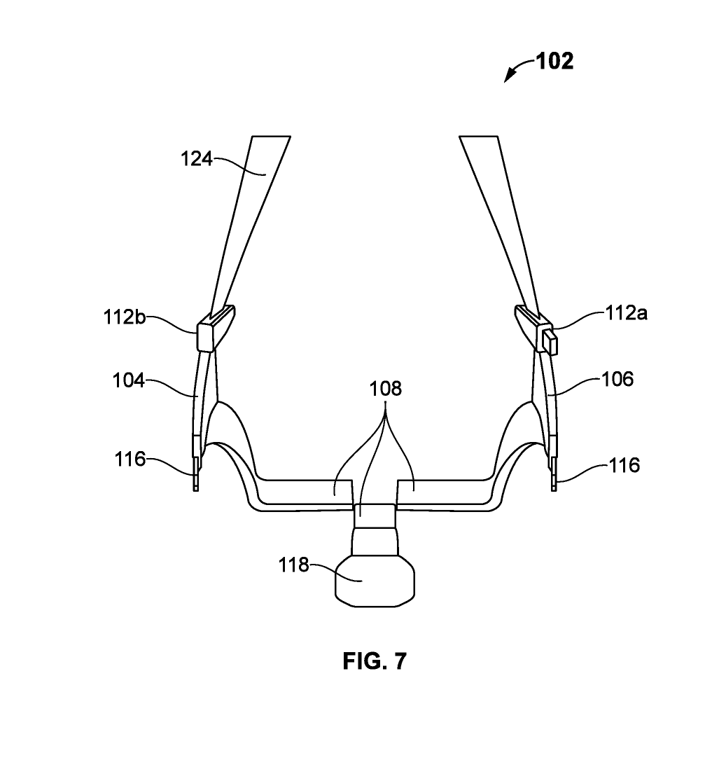

FIG. 7 illustrates the front view of the attachment frame 102 in the folded position to provide access for the child seated in the existing seat belt 124. Once the attachment frame 102 is installed over the existing seat 124, the separate segments (104, 106, 108) of the attachment frame holds the belt 124 open rather than being draped over the child when the 5-point latch is released. This allows much easier access to the child during removal or being placed in the seat. The separate segments (104, 106, and 108) of the attachment frame 102 are easy to install or remove and could be easily be washed if they become soiled. Each of the segments (104, 106, and 108) of the attachment frame 102 rotates into the upright position when the existing seat belts 124 are unlatched. This lowers the front section 110 between the legs to become parallel to the seat top and the two side segments (104, 106) move the seat belt 124 outboard and vertical, providing an empty car eat into which it is easy to place or remove the child. This provides a reasonable degree of compliance and follow the belt 124 as they are comfortably secured against the child when the 5-point latch is fully engaged.

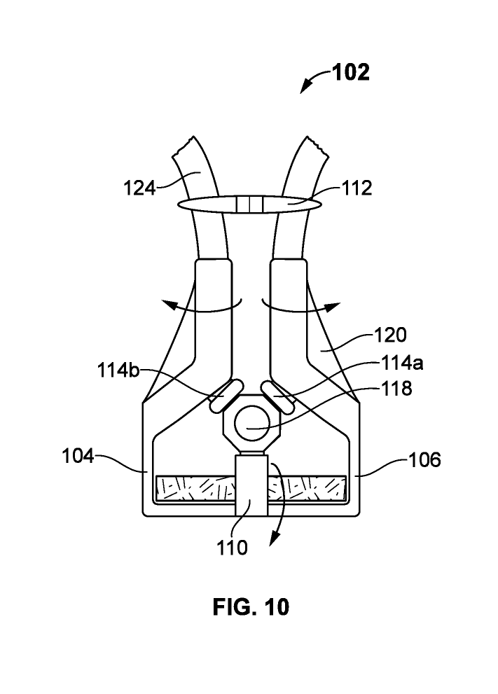

Referring to FIG. 10, the separate segments (104, 106, and 108) of the attachment frame 102 are injection molded from polypropylene plastic. This plastic is very durable, is highly compliant, is impervious to most household and vehicular chemicals, and is typically used in this type of application. These segments (104, 106, and 108) could be supplied in almost any vibrant color, so a distinctive color may be chosen to enhance the product recognition factor of the attachment frame 102.

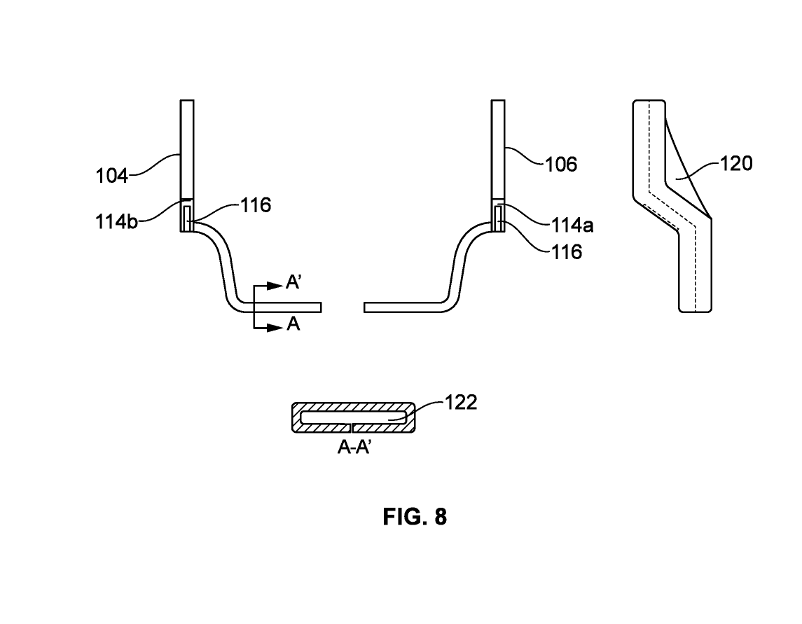

As shown in FIG. 8, each plastic component is shaped in the mold and has a thin slot 122 in the back that allows the attachment frame 102 to be opened to snap the existing seat belt 124. The attachment frame 102 then returns to the original shape, gently wrapping around the existing seat belt 124. When the seat belt 124 is installed in the side segments (104, 106) of the attachment frame 102, the metal tongue 116 that goes into the 5-point harness is positioned so it protrudes through the slot 122 in the corner of the vertical section, allowing it to be latched into the 5-point latch normally. In use, the attachment frame 102 follows the seat belt 124 and conforms to the child's body. Upon release of the 5-point latch, the shoulder belt segments (104, 106) rotate the belts outward until they are vertical, parallel to the outer edges of the seat. The back side is reinforced with a triangle 120 of plastic, which prevents tilting forward and guides the attachment frame 102 to fold over the child when the seat belt 124 is buckled into the center latch.

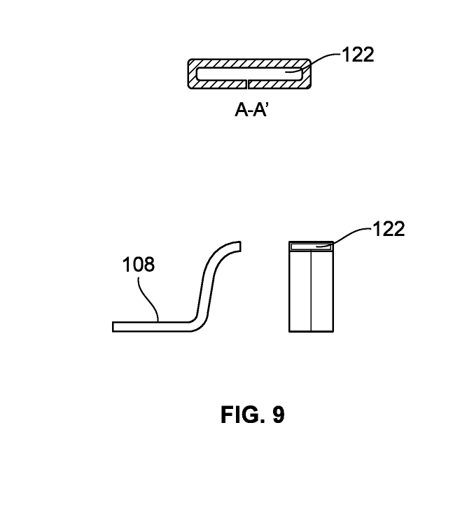

In one embodiment as shown in FIG. 9, the front section 110 is shown in the upright position and lies down almost flat when the 5-point latch is released. This forces the crotch belt and buckle to be positioned almost parallel with car seat cushion, allowing the child to be loaded without any belt or buckle interference. The belt joiner latch is supplied as part of the child's safety seat and when the 5-point latch is released, the segments (104, 106, and 108) return to their ambient state and allow the caregiver unfettered access to the child as shown in FIG. 10.

The preferred embodiments of the present invention disclose the attachment frame 102 for the child safety seat belt 100 in any vehicle. This attachment frame 102 allows the caregiver more easily place or remove the child from the seat. The attachment frame 102 could be easily and quickly installed and removed with comfort and convenience. The compliance of the attachment frame 102 also insures they do not degrade the safety features of the belts if an accident occurs. The attachment frame 102 is made from the flexible plastic material and eliminates the fumbling of the connection joints to provide clear access for loading and unloading the child from the car seat.

In another embodiment, the child safety seat belt 100 is configured for use in association with the seat of a car having one or more seat belt. In another embodiment, the child safety seat belt comprises an attachment frame and a connection joint. The attachment frame comprising one or more segments configured to snap onto the seat belt, wherein each segment is made of flexible material. The connection joint is configured to juxtapose the one or more segments. Each segment is configured to hold the belts open on releasing the connection joint, thereby avoiding draping of seat belts.

Although a single embodiment of the invention has been illustrated in the accompanying drawings and described in the above detailed description, it will be understood that the invention is not limited to the embodiment developed herein, but is capable of numerous rearrangements, modifications, substitutions of parts and elements without departing from the spirit and scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A seat belt attachment for use in association with a seat of a car having at least two shoulder belts leading from laterally spaced-apart locations on a seat back above the locations of the shoulders and a front belt leading from a front center portion of a seat bottom, comprising:
an attachment frame comprising at least three segments configured to snap onto the pair of shoulder belts and the front belt, respectively, and
a connection joint configured to juxtapose the at least three segments, wherein the connection joint comprises a first connection member, a second connection member and a third connection member,
wherein each segment is configured to hold the belts open on releasing the connection joint, thereby avoiding draping of seat belts.

2. The seat belt attachment of claim 1, wherein the first connection member is disposed at an upper section of the shoulder strap.

3. The seat belt attachment of claim 1, wherein the second connection member is disposed at a middle section of the seat belt attachment.

4. The seat belt attachment of claim 1, wherein the third member is disposed at a front section of the seat belt attachment.

5. The seat belt attachment of claim 1, wherein the first connection member is a belt joiner latch.

6. The seat belt attachment of claim 1, wherein the second connection member comprises a metal tongue.

7. The seat belt attachment of claim 1, wherein the second connection member and the third connection member are fastened together via a five-point latch.

8. The seat belt attachment of claim 1, wherein each segment is made of flexible material.

9. The seat belt attachment of claim 1, wherein each segment is made of flexible plastic material.

10. The seat belt attachment of claim 1, wherein each segment is made of polypropylene.

11. A seat belt attachment for use in association with a seat of a car having one or more seat belt, comprising:
an attachment frame comprising one or more segments configured to snap onto the seat belt, wherein each segment is made of flexible material, and
a connection joint configured to juxtapose the one or more segments,
wherein each segment is configured to hold the belts open on releasing the connection joint, thereby avoiding draping of seat belts.

12. The seat belt attachment of claim 11, wherein the one or more segments are juxtaposed via a latch.

13. The seat belt attachment of claim 11, wherein each segment is made of polypropylene.
